(19) United States
(12) Patent Application Publication
(10) Pub. No.: US 2008/0205072 A1
(43) Pub. Date: Aug. 28, 2008

(54) Motor Vehicle Low-Beam Headlight System

(75) Inventor: Jean-Loup Chretien, Morlaix (FR)

Correspondence Address: BANNER & WITCOFF, LTD., 1100 13th STREET, N.W., SUITE 1200, WASHINGTON, DC, 20005-4051, US

(73) Assignee: TIETRONIX OPTICS, Lannion (FR)

(21) Appl. No.: 11/667,016

(22) PCT Filed: Nov. 7, 2005
(86) PCT No.: PCT/FR05/02772

§ 371 Date: Aug. 22, 2007

(30) Foreign Application Priority Data
Nov. 5, 2004 (FR) 0452545

(51) Int. Cl. B60Q 1/00; B60Q 1/02

(52) U.S. Cl. 362/466; 315/82

(57) ABSTRACT

The invention relates to a low-beam headlight system for at least two motor vehicles, comprising a first illuminating device on a first vehicle and a second illuminating device on a second vehicle, each of the devices being provided with main road illuminating means. The first device furthermore comprises additional illuminating means directed laterally with respect to the longitudinal axis of said first vehicle emitting in a predetermined wavelength band, and the second device comprises an electronic road viewing equipment able to capture and retrieve an image of said road when it is illuminated in said predetermined wavelength band by said lateral illuminating means. The system furthermore comprises means of reducing the dazzling of said second vehicle when the additional illuminating means are activated and/or detected by the second device.

The present invention relates to a low-beam headlight system between a first motor vehicle and at least a second motor vehicle, for the purpose of improving the night vision of the driver of said second motor vehicle, the system comprising a first illuminating device installed on first vehicle and a second illuminating device installed on the second vehicle, each device comprising main illuminating means directed essentially along the longitudinal axis of the corresponding vehicle and emitting in the visual wavelength band of the driver of that vehicle and at least one of the devices comprising additional lateral illuminating means.

Lateral illuminating systems are for example known from the patent U.S. Pat. No. 5,067,055 in which the vehicle is provided with lateral lamps illuminating the sides of the vehicle for the persons getting into or out of it.

There are also known similar devices emitting in invisible wavelengths of the spectrum, infrared in particular, for the analysis of the close vicinity and the detection of obstacles. In particular, in the patent applications EP 1 466 785 and JP 2004/299558, a camera/infrared imagery system makes it possible to make use of the lateral illumination emitted by the vehicle in order to provide an image of the lateral zone.

There are also known obstacle detection systems (US 2002/0005778) and distance detectors (U.S. Pat. No. 6,038,496) for motor vehicles comprising one or more infrared emitters and infrared receivers for analyses of the reflected signals.

These systems provide additional “vision” in the close environment of the vehicle but have disadvantages. They to not make it possible, in fact, to avoid dazzling the passed vehicle traveling in the opposite direction, whilst retaining good vision of the road; they can even degrade the vision of other drivers by being additional sources of dazzle. They are more egocentric and do not therefore provide help to other drivers, particularly when the latter come towards them.

In other words, the current systems do not make it possible to solve the problems that have existed for a long time, which can be expressed as follows.

Whilst driving at night, the use of headlights (main illumination) is sufficient. On the other hand, when a vehicle comes in the opposite direction, the main illumination is most often reduced (full beam lights changed to low-beam lights) whilst the opposing lights tend to dazzle the driver and to reduce his road vision capabilities, in particular in the surroundings of the vehicle to be passed. In fact if lighting systems are known (EP 1 334 869) equipping a vehicle and allowing the showing on the roadway of the path taken by that vehicle, such a showing in the visible spectrum particularly allows the driver to see if there are obstacles on the road and/or another motorist or a pedestrian to know the route taken by that vehicle, and to adapt his behavior in consequence.

Such systems however have the disadvantage of not being usable when two vehicles are, at night, in opposite directions and in the approach phase since their mutual headlamps dazzle them. The drivers are then unable to retrieve this information from the visible spectrum.

A second disadvantage of the systems of said prior art is that it can only indicate a possible position of a vehicle but does not provide any assistance to improve the vision of the roadway for another driver.

When two vehicles pass each other in opposite directions it is important, for both drivers, to be able to determine in a reliable manner the limits of the roadway with respect to the vehicle to be passed in order to take the best position on that roadway and to detect possible obstacles on it (object, pedestrian, animals, etc.).

The systems of the aforesaid prior art do not provide the driver of the vehicle coming in the opposite direction with any indication for vision of the roadway immediately to the side of the vehicle. It is particularly important to know sufficiently in advance the space of the roadway available to the side of the vehicle coming in the opposite direction and to be able to follow it throughout the passing phase.

One of the purposes of the present invention is therefore to overcome the abovementioned disadvantages.

For this purpose, there is provided essentially according to the present invention a low-beam headlight system for at least two motor vehicles, comprising a first road illuminating device able to be installed on a first vehicle and a second road illuminating device able to be installed on a second vehicle, each of the devices comprising main road illuminating means arranged to direct the illumination essentially along the longitudinal axis of the vehicle on which it is installed. The first device furthermore comprises additional illuminating means directed laterally with respect to the longitudinal axis of said first vehicle emitting in a predetermined wavelength band, the second device comprises an electronic road viewing equipment able to capture and retrieve an image of said road when it is illuminated in said predetermined wavelength band by said lateral illuminating means of said first device, and the system comprises means of reducing the dazzling of said second vehicle when said additional illuminating means are activated and/or detected by the second device.

The electronic viewing equipment of the second vehicle provides the driver of the latter with an image representing the roadway illuminated to the side of the first vehicle to be passed. To do this, the first vehicle which comes in the opposite direction illuminates the side of the roadway through which the second vehicle will pass, this illumination having then to be “visible” by said electronic viewing equipment.

The reducing means can be at least partly constituted by means allowing the change, automatically or manually by the driver of the first vehicle, from the “headlights” or “off” mode to the “dipped” mode simultaneously or substantially simultaneously with the activation of the additional lateral illumination.

However, the means of reducing the dazzle advantageously rather comprise, alone or in combination, an active anti-dazzle filter in order not to be disturbed in particular by the main illumination of the first vehicle.

Such a filter is for example of the type described in the documents WO 2004/097497 and FR 2 864 740. Such a filter is typically constituted by a light modulator (LCD, DMD and more generally any form of optical modulator) placed in the focal plane of an input lens and placed upstream of electronic viewing equipments, said modulator presenting a masking image attenuating the zones of high light intensity, this image being determined by means of a sensor.

In an advantageous embodiment the first and second devices are identical and/or comprise means providing the same functions, thus allowing the two vehicles which pass each other in opposite directions to provide each other with the same service, furthermore by so doing greatly improving the safety of night driving.

It is recalled that a great proportion of road accidents occur at night and that poor illumination combined with the dazzling of drivers of vehicles which pass each other in opposite directions and the poor visual performance of drivers at night, causes of fatigue and poor appreciation of distances and obstacles, are the essential reasons for it.

Also advantageously, in order to optimize night vision and to overcome the interference that the main illumination of vehicles could generate, said additional illumination emits in an invisible wavelength band.

For example, this additional illumination emits in the infrared band.

In one embodiment, said additional lateral illumination is uniquely directed to the side of the passing zone, that is to say the lane used by vehicles coming in the opposite direction.

Passing zone refers to the zone of the roadway used by the second vehicle arriving in the opposite direction, in the vicinity of the first vehicle to be passed, that is to say substantially on the left-hand side of the first vehicle if driving is carried out on the right-hand side.

In order to optimize the illumination of said passing zone, the additional illuminating means are arranged to illuminate the roadway to the side of the first vehicle but also in front of that vehicle, the lateral illumination thus being directed between 40 and 90 degrees with respect to the longitudinal axis.

In another advantageous embodiment and, in order to provide the driver of the second vehicle with information on a greater part of the roadway, in particular the roadway separating the two vehicles during the approach phase, the illumination system of the first device furthermore comprises an axial illumination emitting in the same wavelength band as said lateral illumination, corresponding to the predetermined sensitivity wavelength band of the electronic viewing equipment of said second vehicle.

Also advantageously, an anti-dazzle filter is provided on the electronic equipment of the second vehicle and therefore provides increased importance since this axial illumination of the first vehicle can become dazzling when the two vehicles are close to each other.

Furthermore, in order to combine the axial illumination and the lateral illumination in an optimal way, the lateral illumination is dedicated to illuminating principally the side of the first vehicle, this lateral illumination is therefore directed at 80°±10° with respect to the longitudinal axis, the vehicle also being equipped with a frontal infrared lamp.

Also advantageously, in order to optimize the electrical consumption and to increase the range of the axial lamp, the system comprises an axial (frontal) infrared illumination comprising a flashing-lamp.

The invention also relates to an illumination system for a motor vehicle comprising a main illumination directed essentially along the longitudinal axis of the vehicle and emitting in the visual wavelength band of the driver of said vehicle, said system comprising an additional lateral illumination, emitting in an invisible wavelength band that can be sensed by electronic viewing equipment equipping at least a second vehicle as well as electronic night vision equipment whose sensitivity band corresponds to the emission band of a lateral illumination equipping said second vehicle, the system being equipped with means for limiting dazzle. Advantageously, in order to do this, these electronic viewing equipments contain an active anti-dazzle filter in order not to be interfered with by the main illumination of other vehicles.

Because of the altruistic nature of the invention, it is understood here that it is advantageous to provide all of the vehicles running at the same time with the lateral (and possibly axial) illumination device and with the electronic viewing equipment.

In an advantageous embodiment, said electronic night viewing equipment comprises an infrared camera and a means of displaying the image acquired by said camera in the driver's field of vision, for example comprising a flat screen of the LCD type or a heads-up display system, disposed in the driver's field of vision without risk of otherwise disturbing his vision of the road, and microprocessor and image processing programming means known per se.

Advantageously, the means of reducing dazzle making it possible to optimize the use of this lateral illumination, comprise means of coupling the switching on of the additional means constituting the lateral and/or axial illumination for example comprising infrared lamps with the switching on of the normal low-beam headlights. Similarly, the switching off of these additional illumination means such as infrared lamps is coupled with the change to “headlight” or “off” mode of the main illumination using visible light.

In fact, drivers are persuaded to change from their main illumination mode to their low-beam mode when a vehicle is coming in the opposite direction.

The invention also relates to an illumination system for a motor vehicle designed to be used with the low-beam headlight system for at least two motor vehicles such as described above.

It also relates to a vehicle equipped with such an illumination system, and to a series of at least two vehicles equipped with a low-beam headlamp system such as described above.

The invention also relates to an illumination system for a motor vehicle comprising a device comprising main road illumination means arranged to direct the illumination essentially along the longitudinal axis of the vehicle on which it is installed, additional illumination means directed laterally with respect to the longitudinal axis of said vehicle emitting in a predetermined wavelength band, characterized in that said illumination system furthermore comprises an electronic road viewing equipment able to capture and retrieve an image of said road when it is illuminated in said predetermined wavelength band, and in that the system comprises means of reducing the dazzling by another vehicle passing it in the opposite direction when said additional illumination means are activated and/or detected.

Advantageously, the vehicle is equipped with an additional illumination system operating in an invisible spectrum, said additional illumination being directed to the side of the traffic lane of vehicles coming in the opposite direction and said additional illumination forming a beam whose axis is directed at between 40 and 90 degrees with respect to the forward longitudinal axis of the vehicle. The illumination provided by this vehicle can then be used by any other vehicle provided with electronic night viewing means in order to improve the driver's vision.

Possibly, said axis of the beam is directed at 80 degrees ±10° with respect to the forward longitudinal axis of the vehicle.

The invention also relates to a method of illumination of the road by the passing in opposite directions of at least two motor vehicles, a first vehicle comprising additional means of lateral illumination of the road in a predetermined wavelength and a second vehicle comprising an electronic viewing equipment, able to capture and retrieve an image of said road when it is illuminated in said predetermined wavelength band, said method comprising:

a step of illuminating in the invisible range by the first vehicle a part of the traffic lane of the second vehicle, coming in the opposite direction,

a step of electronic viewing, by the driver of said second vehicle, of said traffic lane at the level of said first vehicle, by the detection of the invisible illumination emitted by the first vehicle, and the display in the visible spectrum of the image detected such that the result of this is an improvement in the night vision of a driver of a first vehicle and, simultaneously or substantially simultaneously,

a step of reducing the dazzling of said second vehicle when said additional illumination means are activated and/or detected by the second device.

Other purposes and advantages of the present invention will appear in the following detailed description of it.

The invention will also be better understood with reference to the following drawings, in which the same references denote identical or similar items:

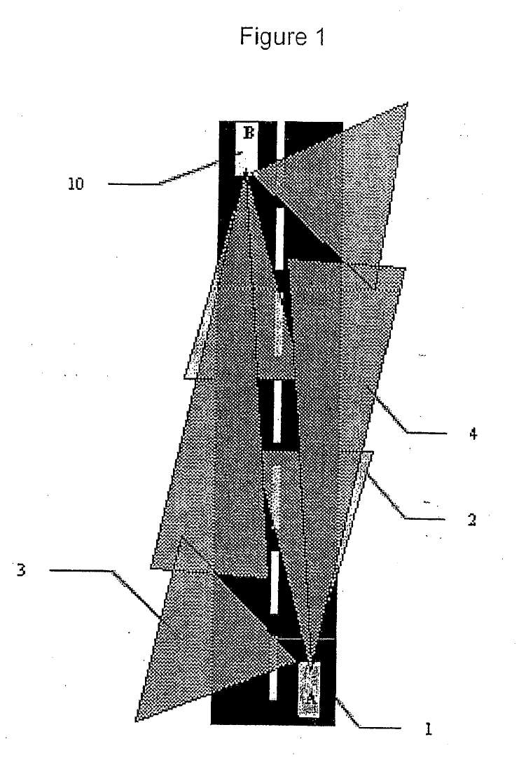

FIG. 1 is a plan view of two vehicles moving in opposite directions and equipped with a low-beam headlight system according to one embodiment of the invention;

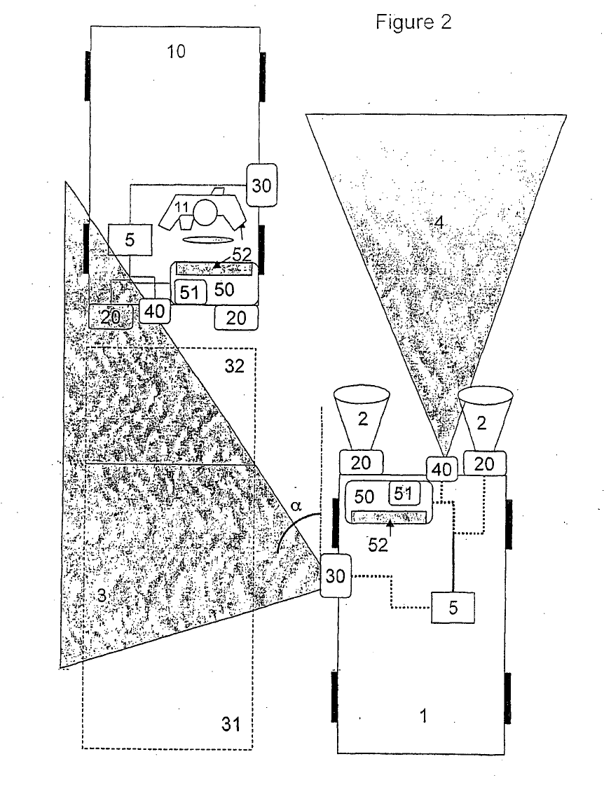

FIG. 2 is a diagram showing the principle of the embodiment of the low-beam headlight system shown in FIG. 1.

FIG. 1 shows two motor vehicles (1, 10) traveling in opposite directions on a two lane road. Each of the two vehicles is moving on “its” right hand lane.

According to the embodiment of the invention described more particularly here, each vehicle is firstly equipped with main illumination means 2, of the traditional frontal type, formed by headlights, dipped lights (low-beam headlights) and of lamps emitting visible light for the driver essentially in the axis of the vehicle. This main frontal illumination in particular illuminates the roadway located in front of the driver. Generally, this illumination also illuminates a part of the second lane and a part of the right-hand verge off of the road. Optionally, theses headlights can be directed and slaved to the steering of the vehicle.

According to this embodiment of the invention, the two vehicles are furthermore equipped with additional illumination means 3 directed laterally with respect to the longitudinal axis of the vehicles, oriented towards the left for vehicles intended for countries where driving is on the right-hand lane, said illumination means emitting in a predetermined wavelength band, for example in an infrared wavelength, that is to say included in the electromagnetic spectrum between visible light and microwaves and, in particular, advantageously close to visible light.

The system furthermore comprises, on each of the vehicles, means of detection and of display of this additional illumination by the respective drivers and of reducing the frontal light when the latter is in headlight mode, means which will now be described more particularly with reference to FIG. 2.

More precisely, with reference to FIG. 2, this lateral illumination 3 is for example formed by an infrared lamp of high power 30, for example 200 W, oriented in such a way as to form a beam whose axis is directed at between 40 and 90 degrees with respect to the longitudinal axis of the vehicle, that is to say the illumination is effective to the side of vehicle zone 31, and on the part of the lateral lane in front in the direction of the vehicle with respect to the position of the vehicle (zone 32). This direction a will preferably be at 80°±10° when the vehicle is also equipped with a frontal infrared lamp 40 for an axial illumination 4. Such adjustments can be made automatically depending on the switching on of the frontal headlight 4 and possibly depending on the speed of the vehicle. Control means that are known per se are then provided for this purpose.

This lateral illumination illuminates the verges of the road, that it to say the left hand lane for the vehicle 1 and therefore the lane used by the vehicle 10 as well as the edge of the roadway, and improves the night vision of the driver 11 of the vehicle 10 approaching on the opposite lane. Each vehicle is equipped with an imaging means 50 making it possible to reconstitute an image in the visible spectrum from the infrared lateral illumination 3, for example using an infrared camera 51 of the CCD (Charge Coupled Device) type and a display device 52 of known type, the assembly 50 being commanded and controlled by appropriate electronic means 5 and/or arranged and/or programmed in a way that is known per se in order to carry out the necessary functions.

This device makes it possible to increase the infrared vision zone I/R of the drivers of two vehicles passing each other in opposite directions.

Optionally, the vehicles 1, 10 are equipped with a frontal infrared lamp 40 in order to produce an axial illumination 4, making it possible for the driver of the vehicle thus equipped to improve the night vision through his night vision equipment 50.

The switching on of these infrared lamps 30, 40 is coupled with the switching on of the normal low-beam headlights 20 producing the main visible illumination of the vehicle, the switching off of these infrared lamps 30, 40 being coupled with the change to “headlight” or “off” mode of the main illumination 2 in visible light, through control means 5, such coupling means thus forming the means of reducing the dazzling of the facing driver.

However, these reducing means can also be uniquely formed by and/or include an active anti-dazzle filter of the type described.

The functioning of the low-beam headlight system according to the embodiment described more particularly here will now be described.

The driver of the vehicle 1 driving at night in “headlight” mode sees the gleam of the lights of a second vehicle 10 coming in the opposite direction. He then changes to “dipped” mode, using engagement means, which will reduce the dazzling of the facing driver.

Simultaneously, the lateral illumination is switched on which projects an infrared beam onto the side on which will pass the second vehicle which is fitted with a device provided with an electronic viewing equipment comprising an anti-dazzle filter such as for example described in the documents WO 2004/097497 and FR 2 864 740.

The result of this is an optimized illumination of the road for the second vehicle and a reduction of the risks of accident.

The second vehicle does the same thing, this time improving the vision and safety of the first vehicle. Once the passing is completed, each of the vehicles returns to “headlight mode”, the lateral illumination being switched off.

In order to increase the range of the frontal infrared lamp 40 illuminating forwards, it can be constituted by a lamp flashing at an adapted frequency (18 to 24 flashes/sec). The camera 51 retains the image at the moment of illumination in memory until the next flash.

1. A low-beam headlight system for at least two motor vehicles, comprising a first road illuminating device configured to be installed on a first vehicle and a second road illuminating device configured to be installed on a second vehicle, each of the devices comprising main road illuminating means arranged to direct the illumination substantially along the longitudinal axis of the vehicle on which it is installed, wherein:
the first device comprises additional illuminating means directed laterally with respect to the longitudinal axis of said first vehicle emitting in a predetermined invisible wavelength band,
the second device comprises an electronic road viewing equipment able to capture and retrieve an image of said road in a zone illuminated in said predetermined wavelength band by said lateral illuminating means of said first device, and
the system comprises means of reducing dazzling, wherein said means of reducing dazzling includes an optical modulator presenting a masking image attenuating zones of high light intensity of said second vehicle when said additional illuminating means are activated or detected by the second device.

2. The system as claimed in claim 1, wherein the reducing means are at least partly constituted by means allowing a change, automatically or manually by a driver of the first vehicle, from a “headlights” or “extension” mode to a “dipped” mode simultaneously or substantially simultaneously with the activation of the additional lateral illumination.

3. The system as claimed in claim 1, wherein the dazzle reducing means comprises an active anti-dazzle filter, adjoined to the second device and arranged to reduce the impact of the main illumination of the first vehicle.

4. The system as claimed in claim 1, wherein the first and second devices comprise means providing the same functions.

5. The system as claimed in claim 1, wherein said additional illumination emits in the infrared band.

6. The system as claimed in claim 1, wherein the additional lateral illumination means is arranged to direct the illumination uniquely on a side of a passing zone.

7. The system as claimed in claim 1, wherein the system comprises an axial illumination means emitting in the same wavelength band as said lateral illumination.

8. The system as claimed in claim 1, wherein the lateral illumination is directed between 40 and 90 degrees with respect to the longitudinal axis of the first vehicle.

9. The system as claimed in claim 1, wherein at least one of the devices comprises a frontal infrared illumination comprising a flashing lamp.

10. The system according to claim 1, wherein said system comprises an infrared camera and a screen for displaying an image acquired by said camera in a driver's field of vision.

11. An illumination system for a motor vehicle comprising main illumination means arranged to direct the illumination substantially along the longitudinal axis of the vehicle on which it is installed, additional illumination means directed laterally with respect to the longitudinal axis of said vehicle emitting in a predetermined invisible wavelength band, wherein said illumination system furthermore comprises electronic road viewing equipment able to capture and retrieve an image of a road in the zone illuminated in said predetermined wavelength band by another vehicle, and in that the system comprises means of limiting dazzling comprising an optical modulator presenting a masking image attenuating the zones of high light intensity for another facing vehicle passing it in the opposite direction when said additional illumination means are activated or detected.

12. A motor vehicle equipped with the illumination system of claim 11.

13. A method of illumination of a road by the passing in opposite directions of at least two motor vehicles, a first vehicle comprising additional means of lateral illumination of the road in a predetermined wavelength and a second vehicle comprising an electronic viewing equipments, wherein said electronic viewing equipment is configured to capture and retrieve an image of said road when it is illuminated in said predetermined wavelength band, said method comprising:
illuminating in the invisible range by the first vehicle a part of a traffic lane of the second vehicle, wherein the first vehicle and the second vehicle are traveling in opposite directions,
responsive to detecting the invisible illumination emitted by the first vehicle, said electronic viewing equipment providing the image of said road to a driver of the second vehicle, and, simultaneously or substantially simultaneously,
reducing a dazzling of said second vehicle when said additional illumination means are activated or detected by the second device.
